(19) United States
(12) Patent Application Publication
(10) Pub. No.: US 2021/0306114 A1
(43) Pub. Date: Sep. 30, 2021

(54) SIDELINK FEEDBACK MESSAGING

(71) Applicant: QUALCOMM Incorporated, San Diego, CA (US)

(72) Inventors: Sony AKKARAKARAN, Poway, CA (US); Jelena DAMNJANOVIC, Del Mar, CA (US); Tao LUO, San Diego, CA (US); Juan MONTOJO, San Diego, CA (US); Aleksandar DAMNJANOVIC, Del Mar, CA (US)

(21) Appl. No.: 17/211,273

(22) Filed: Mar. 24, 2021

Related U.S. Application Data
(60) Provisional application No. 63/000,893, filed on Mar. 27, 2020.

(51) Int. Cl. H04L 1/18; H04W 72/14; H04W 72/12

(52) U.S. Cl. CPC H04L 1/1896; H04W 72/1263; H04W 72/1257; H04W 72/14

(57) ABSTRACT

Various aspects of the present disclosure generally relate to wireless communication. In some aspects, a wireless communication device may receive at least one sidelink communication on a sidelink, wherein the at least one sidelink communication includes at least one of a grant, a plurality of data packets or relaying data received on a resource identified by a grant, a multi-stage grant, a multi-packet grant, or a relaying communication; and transmit, on the sidelink, at least one feedback message acknowledging receiving the at least one sidelink communication. Numerous other aspects are provided.

### CROSS-REFERENCE TO RELATED APPLICATION

This Patent Application claims priority to U.S. Provisional Patent Application No. 63/000,893, filed on Mar. 27, 2020, entitled “SIDELINK FEEDBACK MESSAGING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for sidelink feedback messaging.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication, performed by a wireless communication device, may include receiving at least one sidelink communication on a sidelink, wherein the at least one sidelink communication includes at least one of a grant, a plurality of data packets or relaying data received on a resource identified by a grant, a multi-stage grant, a multi-packet grant, or a relaying communication; and transmitting, on the sidelink, at least one feedback message acknowledging receiving the at least one sidelink communication.

In some aspects, a wireless communication device for wireless communication may include a memory and one or more processors coupled to the memory. The memory and the one or more processors may be configured to receive at least one sidelink communication on a sidelink, wherein the at least one sidelink communication includes at least one of a grant, a plurality of data packets or relaying data received on a resource identified by a grant, a multi-stage grant, a multi-packet grant, or a relaying communication; and transmit, on the sidelink, at least one feedback message acknowledging receiving the at least one sidelink communication.

In some aspects, a non-transitory computer-readable medium may store one or more instructions for wireless communication. The one or more instructions, when executed by one or more processors of a wireless communication device, may cause the one or more processors to receive at least one sidelink communication on a sidelink, wherein the at least one sidelink communication includes at least one of a grant, a plurality of data packets or relaying data received on a resource identified by a grant, a multi-stage grant, a multi-packet grant, or a relaying communication; and transmit, on the sidelink, at least one feedback message acknowledging receiving the at least one sidelink communication.

In some aspects, an apparatus for wireless communication may include means for receiving at least one sidelink communication on a sidelink, wherein the at least one sidelink communication includes at least one of a grant, a plurality of data packets or relaying data received on a resource identified by a grant, a multi-stage grant, a multi-packet grant, or a relaying communication; and means for transmitting, on the sidelink, at least one feedback message acknowledging receiving the at least one sidelink communication.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals necessarily includes a number of components for analog and digital purposes (e.g., hardware components including antennas, RF-chains, power amplifiers, modulators, buffers, processor(s), interleavers, adders, and/or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of sidelink feedback messaging, in accordance with the present disclosure.

FIG. 6 is a diagram illustrating an example process performed, for example, by a wireless communication device, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

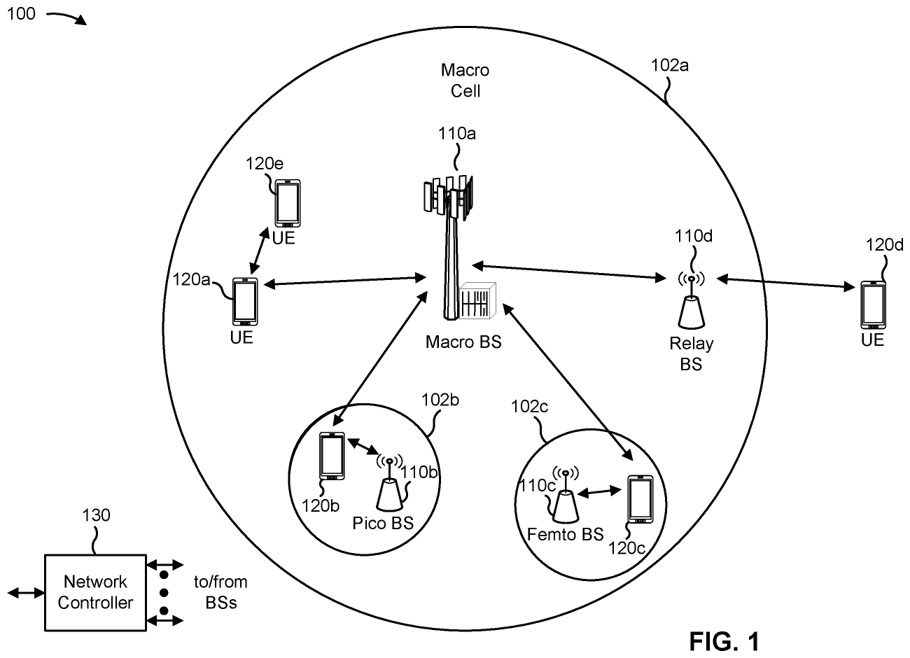

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GH-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

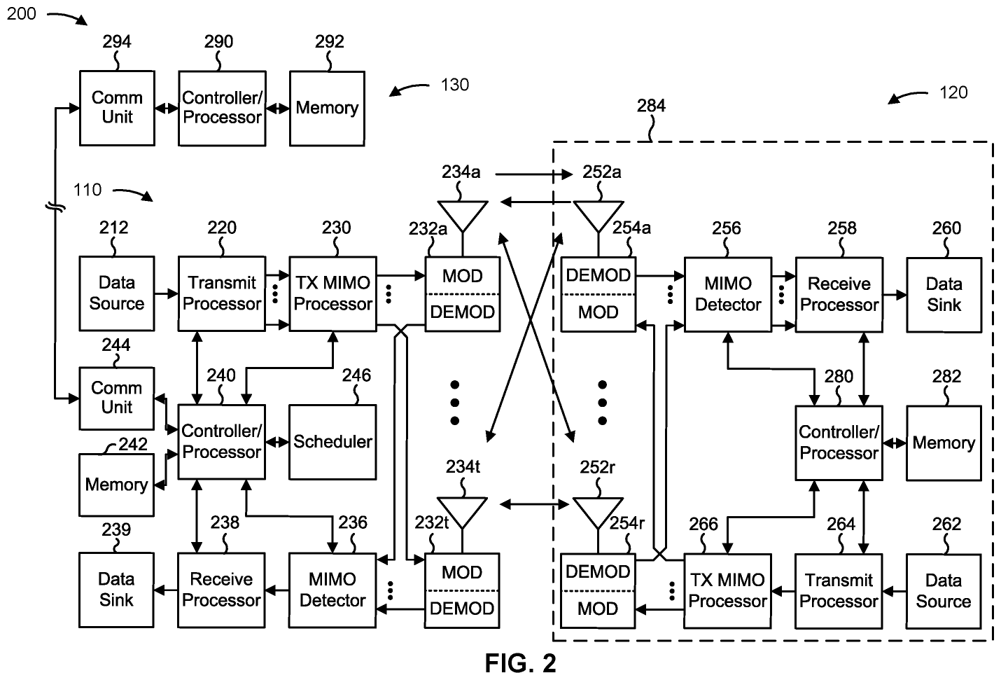

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

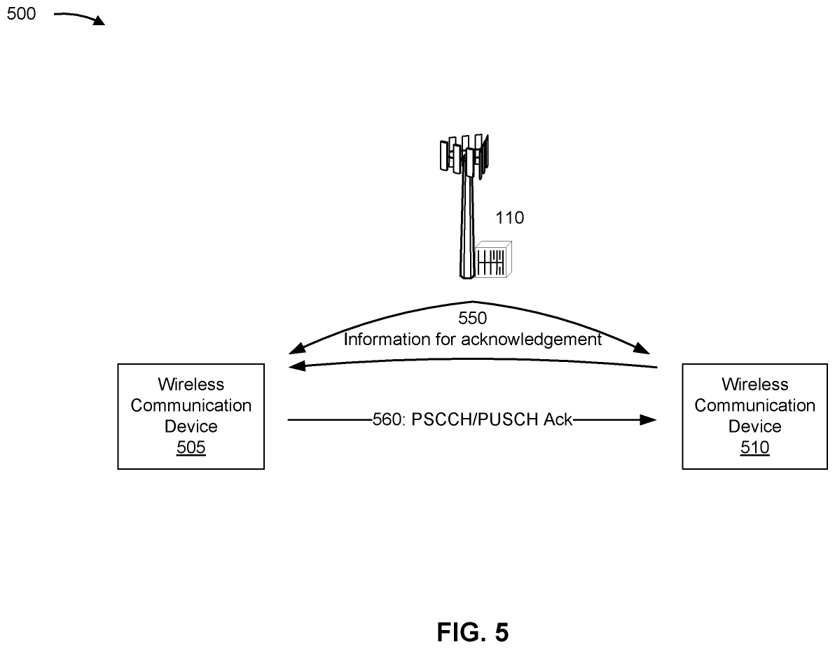

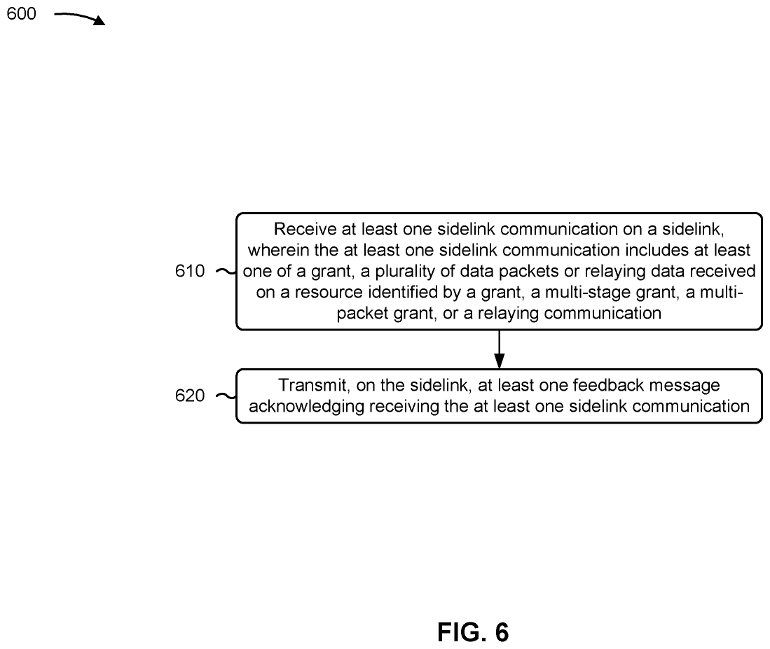

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 5 and 6).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 5 and 6).

Controller/processor 240 of base station 110, controller/processor 280 of UE 120, and/or any other component(s) of FIG. 2 may perform one or more techniques associated with sidelink feedback messaging, as described in more detail elsewhere herein. For example, controller/processor 240 of base station 110, controller/processor 280 of UE 120, and/or any other component(s) of FIG. 2 may perform or direct operations of, for example, process 600 of FIG. 6 and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6 and/or other processes as described herein. In some aspects, executing instructions may include running the instructions, converting the instructions, compiling the instructions, and/or interpreting the instructions, among other examples.

In some aspects, a wireless communication device, such as BS 110 or UE 120, may include means for receiving at least one sidelink communication on a sidelink, wherein the at least one sidelink communication includes at least one of a grant, a plurality of data packets or relaying data received on a resource identified by a grant, a multi-stage grant, a multi-packet grant, or a relaying communication; means for transmitting, on the sidelink, at least one feedback message acknowledging receiving the at least one sidelink communication, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like. In some aspects, such means may include one or more components of BS 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

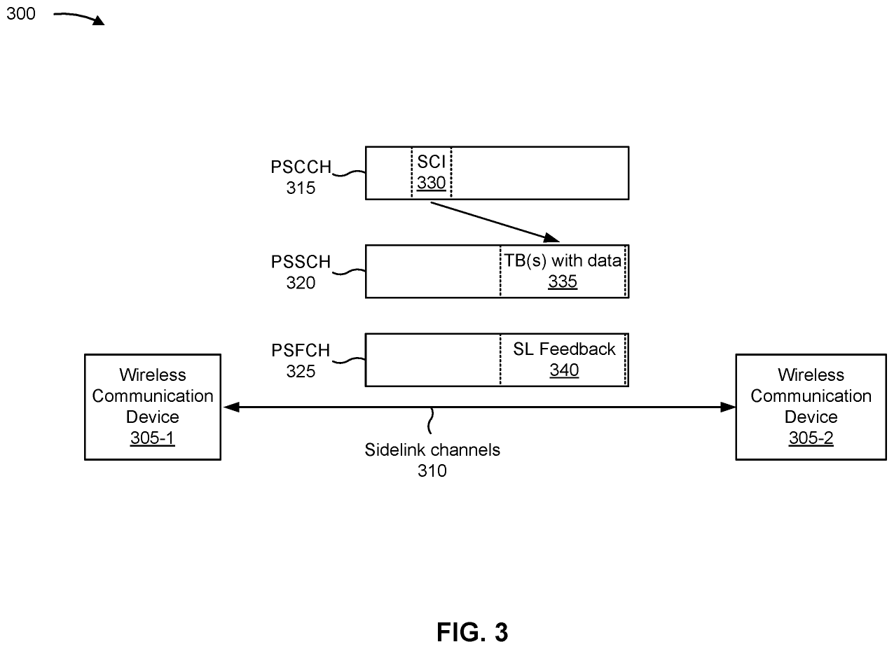

FIG. 3 is a diagram illustrating an example 300 of sidelink communications, in accordance with various aspects of the present disclosure.

As shown in FIG. 3, a first wireless communication device 305-1 may communicate with a second wireless communication device 305-2 (and one or more other wireless communication devices 305) via one or more sidelink channels 310. The wireless communication devices 305-1 and 305-2 may communicate using the one or more sidelink channels 310 for P2P communications, D2D communications, V2X communications (e.g., which may include V2V communications, V2I communications, and/or vehicle-to-pedestrian (V2P) communications), and/or mesh networking, among other examples. In some aspects, the wireless communication devices 305 (e.g., wireless communication device 305-1 and/or wireless communication device 305-2) may correspond to one or more UEs 120, BSs 110, and/or integrated access and backhaul (IAB) nodes, among other examples. In some aspects, the one or more sidelink channels 310 may use a PC5 interface and/or may operate in a high frequency band (e.g., the 5.9 GHz band). Additionally, or alternatively, the wireless communication devices 305 may synchronize timing of transmission time intervals (TTIs) (e.g., frames, subframes, slots, and/or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a BS 110 via an access link or an access channel The PSSCH 320 may be used to communicate data, similar to a physical downlink shared channel (PDSCH) and/or a physical uplink shared channel (PUSCH) used for cellular communications with a BS 110 via an access link or an access channel For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR), among other examples.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a wireless communication device 305 may operate using a transmission mode where resource selection and/or scheduling is performed by the wireless communication device 305 (e.g., rather than a BS 110). In some aspects, the wireless communication device 305 may perform resource selection and/or scheduling by sensing channel availability for transmissions. For example, the wireless communication device 305 may measure an RSSI parameter (e.g., a sidelink-RSSI (S-RSSI) parameter) associated with various sidelink channels, may measure a RSRP parameter (e.g., a PSSCH-RSRP parameter) associated with various sidelink channels, and/or may measure a RSRQ parameter (e.g., a PSSCH-RSRQ parameter) associated with various sidelink channels, among other examples, and may select a channel for transmission of a sidelink communication based at least in part on the measurement(s).

Additionally, or alternatively, the wireless communication device 305 may perform resource selection and/or scheduling using SCI 330 received in the PSCCH 315, which may indicate occupied resources, and/or channel parameters, among other examples. Additionally, or alternatively, the wireless communication device 305 may perform resource selection and/or scheduling by determining a channel busy rate (CBR) associated with various sidelink channels, which may be used for rate control (e.g., by indicating a maximum number of resource blocks that the wireless communication device 305 can use for a particular set of subframes).

In the transmission mode where resource selection and/or scheduling is performed by a wireless communication device 305, the wireless communication device 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a MCS to be used for the upcoming sidelink transmission, among other examples. In some aspects, a wireless communication device 305 may generate a sidelink grant that indicates one or more parameters for semi-persistent scheduling (SPS), such as a periodicity of a sidelink transmission. Additionally, or alternatively, the wireless communication device 305 may generate a sidelink grant for event-driven scheduling, such as for an on-demand sidelink message.

As indicated above, FIG. 3 is provided as an example. Other examples may differ from what is described with respect to FIG. 3.

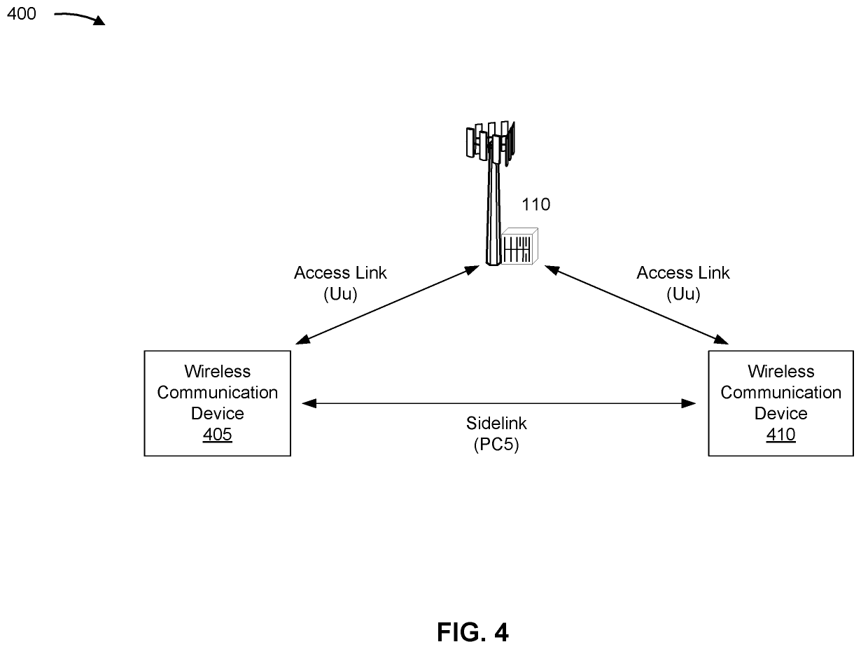

FIG. 4 is a diagram illustrating an example 400 of sidelink communications and access link communications, in accordance with various aspects of the present disclosure.

As shown in FIG. 4, wireless communication device 405 and a wireless communication device 410 may communicate with one another via a sidelink, as described above in connection with FIG. 3. As further shown, in some sidelink modes, a BS 110 may communicate with the wireless communication device 405 via a first access link. Additionally, or alternatively, in some sidelink modes, the BS 110 may communicate with the wireless communication device 410 via a second access link. The wireless communication device 405 and/or the wireless communication device 410 may correspond to one or more UEs 120, BSs 110, and/or IAB nodes, among other examples. As an example, a sidelink may refer to a direct link between UEs 120, and an access link may refer to a direct link between a BS 110 and a UE 120. Sidelink communications may be transmitted on a PC5 interface via the sidelink, and access link communications may be transmitted via the access link. An access link communication may be either a downlink communication (from a BS 110 to a UE 120) or an uplink communication (from a UE 120 to a BS 110) on a Uu interface.

As indicated above, FIG. 4 is provided as an example. Other examples may differ from what is described with respect to FIG. 4.

As described above, a wireless communication device may communicate with a BS on a Uu interface associated with an access link. For example, a wireless communication device may transmit a PUCCH communication on an uplink to convey an acknowledgement message to acknowledge downlink data. Additionally, or alternatively, the wireless communication device may include an acknowledgment message with a PUSCH communication.

Similarly, a first wireless communication device may communicate with a second wireless communication device on a PC5 interface associated with a sidelink. In this case, the first wireless communication device may transmit a feedback message, such as an acknowledgement (ACK) message or negative acknowledgement (NACK) message on PSFCH. In this case, the first wireless communication device may time division multiplex (TDM) a PSCCH, PSSCH, and a PSFCH for transmission. in some cases, such as for V2X communication, the first wireless communication device may not frequency division multiplex (FDM) the aforementioned channels. Using a PSFCH for conveying feedback information may be used for single-stage grants, grants for a single sidelink, and/or other scenarios. However, other types of grants and links, such as multi-stage grants and multi-link connections may be used.

Some aspects described herein enable sidelink feedback messaging. For example, when a wireless communication device receives information, such as a grant, data on a resource identified by a grant, a multi-stage grant, a multi-packet grant, and/or a relaying communication, among other examples, the wireless communication device may transmit one or more feedback messages to acknowledge the information. In this case, the wireless communication device may bundle a plurality of feedback messages into a single feedback message. In this way, the wireless communication device enables relaying grant acknowledgements, and/or multi-stage grant acknowledgements, among other examples.

FIG. 5 is a diagram illustrating an example 500 of sidelink feedback messaging, in accordance with various aspects of the present disclosure. As shown in FIG. 5, example 500 includes a first wireless communication device 505, a second wireless communication device 510, and a BS 110.

As further shown in FIG. 5, and by reference number 550, wireless communication device 505 may receive information for acknowledgement. For example, wireless communication device 505 may receive information for acknowledgement from wireless communication device 510, from BS 110, and/or from BS 110 via wireless communication device 510, among other examples. In some aspects, wireless communication device 505 may receive a grant that wireless communication device 505 is to acknowledge. For example, wireless communication device 505 may receive the grant from BS 110 (e.g., via wireless communication device 510, in some aspects). Additionally, or alternatively, wireless communication device 505 may receive data on a resource granted by a grant and may be triggered to acknowledge the received data (or to negatively acknowledge a failure to receive data on the resource granted by the grant).

In some aspects, wireless communication device 505 may receive a multi-stage grant or a multi-packet grant. For example, wireless communication device 505 may receive a two-stage grant or a higher-stage (e.g., n stage) grant. In the case of a two-stage grant, wireless communication device 505 may receive a stage-1 grant in a SCI of a PSCCH, and the SCI may direct wireless communication device 505 to receive a stage-2 grant in an SCI mapped to a set of contiguous resource blocks in a PSSCH. Additionally, or alternatively, for an n-stage grant, wireless communication device 505 may receive an n-2-stage grant that includes information for decoding an n-1-stage grant (e.g., frequency or time resource information for the n-1-stage grant), which may include information for decoding an n-stage grant (e.g., frequency or time resource information for the n-stage grant), among other examples.

Similarly, for a multi-packet grant, wireless communication device 505 may receive a plurality of independently encoded packets conveying a grant (e.g., or a stage of a multi-stage grant). For example, for a multi-stage, multi-packet grant, a first stage grant may include information identifying a quantity of packets for a second stage grant. Additionally, or alternatively, the quantity of packets may be fixed in a standard. In some aspects, wireless communication device 505 may receive a multi-packet grant for relaying to a plurality of wireless communication devices 510. For example, each packet, of the multi-packet grant, may identify a different wireless communication device 510 to which wireless communication device 505 is to relay the packet.

In some aspects, wireless communication device 505 may receive a multi-packet grant or a multi-stage grant from a plurality of granting sources. For example, wireless communication device 505 may receive a first stage of a grant from BS 110, which may cause wireless communication device 505 to receive a second stage of the grant from wireless communication device 510. In this case, wireless communication device 505 may be triggered to transmit acknowledgement messages to a plurality of different devices (e.g., the plurality of granting sources).

In some aspects, wireless communication device 505 may receive information for relaying. For example, wireless communication device 505 may receive, from wireless communication device 510, a packet for relaying to BS 110 and may acknowledge receipt of the packet for relaying. Additionally, or alternatively, based at least in part on relaying the packet, wireless communication device 505 may receive an acknowledgement of a success of relaying the packet and may relay the acknowledgement to wireless communication device 510, as described in more detail herein.

As further shown in FIG. 5, and by reference number 560, wireless communication device 505 may transmit a feedback message. For example, wireless communication device 505 may transmit the feedback message to wireless communication device 510. Additionally, or alternatively, wireless communication device 505 may transmit a feedback message to a plurality of wireless communication devices 510, and/or to BS 110, among other examples. In some aspects, an acknowledgment for a packet to be relayed may include of one or more of an acknowledgment for having received the packet, an acknowledgment for having relayed the to the next node in the relaying path (e.g., for sending the packet to the next node and receiving an acknowledgment from the next node of having received the packet), an acknowledgment for a downstream node (e.g., the next node) having received the packet and/or having relayed the packet to a further downstream node, among other examples. Additionally, or alternatively, the acknowledgement may include a bundled acknowledgment of one or more of the aforementioned acknowledgments, as described further herein.

In some aspects, wireless communication device 505 may bundle a plurality of acknowledgement feedback messages for transmission. For example, with regard to a multi-stage grant or multi-packet grant, rather than transmitting a separate feedback message for each received packet, wireless communication device 505 may bundle two or more received packets into a single feedback message. In this case, based at least in part on successfully decoding each received packet of a group of received packets, wireless communication device 505 may transmit a single acknowledgement message for the group of received packets. Alternatively, based at least in part on a failure to successfully decode one or more of the group of received packets, wireless communication device 505 may transmit a negative acknowledgement message. In some aspects, wireless communication device 505 may bundle feedback messages related to a common stage. Additionally, or alternatively, wireless communication device 505 may bundle feedback messages related to linked stages. For example, when a first stage of a grant includes information for decoding a second stage of the grant, wireless communication device 505 may bundle feedback messages for the first stage of the grant and the second stage of the grant.

In some aspects, wireless communication device 505 may transmit a feedback message based at least in part on relaying information. For example, wireless communication device 505 may bundle an acknowledgement of a received packet from wireless communication device 510 with an acknowledgement from BS 110 that wireless communication device 505 successfully relayed the received packet to BS 110.

In some aspects, wireless communication device 505 may use a semi-static codebook for a group of bundled feedback messages. For example, wireless communication device 505 may transmit a static quantity of bits that is independent of a quantity of feedback messages that are bundled. Additionally, or alternatively, wireless communication device 505 may dynamically adjust the quantity of bits, such that wireless communication device 505 acknowledges packets of which wireless communication device 505 is aware (e.g., packets for which wireless communication device 505 has received information confirming that the packets are to be transmitted). In this case, wireless communication device 505 and, for example, wireless communication device 510, may communicate a sidelink assignment index to ensure that a mismatch does not occur between a quantity of packets being acknowledged and a quantity of packets that wireless communication device 510 expects to be acknowledged.

In some aspects, wireless communication device 505 may order acknowledgement messages in a bundled feedback message based at least in part on a stage and/or a packet order within a stage. In some aspects, wireless communication device 505 may jointly encode or separately encode acknowledgement bits in a bundled feedback message. In some aspects, wireless communication device 505 may configure bundling based at least in part on a characteristic of a network. For example, for relaying information, wireless communication device 505 may configure which feedback messages to bundle based at least in part on a quantity of hops, and/or a quantity of alternative routes available, among other examples.

As indicated above, FIG. 5 is provided as an example. Other examples may differ from what is described with respect to FIG. 5.

FIG. 6 is a diagram illustrating an example process 600 performed, for example, by a wireless communication device, in accordance with various aspects of the present disclosure. Example process 600 is an example where the wireless communication device (e.g., BS 110; UE 120; and/or wireless communication devices 305, 405, 410, 505, and/or 510) performs operations associated with sidelink feedback messaging.

As shown in FIG. 6, in some aspects, process 600 may include receiving at least one sidelink communication on a sidelink, wherein the at least one sidelink communication includes at least one of a grant, a plurality of data packets or relaying data received on a resource identified by a grant, a multi-stage grant, a multi-packet grant, or a relaying communication (block 610). For example, the wireless communication device (e.g., using antenna 234, DEMOD 232, MIMO detector 236, receive processor 238, controller/processor 240, antenna 252, DEMOD 254, MIMO detector 256, receive processor 258, and/or controller/processor 280) may receive at least one sidelink communication on a sidelink, as described above. In some aspects, the at least one sidelink communication includes at least one of a grant, a plurality of data packets or relaying data received on a resource identified by a grant, a multi-stage grant, a multi-packet grant, or a relaying communication.

As further shown in FIG. 6, in some aspects, process 600 may include transmitting, on the sidelink, at least one feedback message acknowledging receiving the at least one sidelink communication (block 620). For example, the wireless communication device (e.g., using controller/processor 240, transmit processor 220, TX MIMO processor 230, MOD 232, antenna 234, controller/processor 280, transmit processor 264, TX MIMO processor 266, MOD 254, and/or antenna 252) may transmit, on the sidelink, at least one feedback message acknowledging receiving the at least one sidelink communication, as described above.

Process 600 may include additional aspects, such as any single aspect or any combination of aspects described below and/or in connection with one or more other processes described elsewhere herein.

In a first aspect, receiving the at least one sidelink communication includes receiving a first stage of the multi-stage grant from a first wireless node, and receiving a second stage of the multi-stage grant from a second wireless node.

In a second aspect, alone or in combination with the first aspect, transmitting the at least one feedback message includes transmitting a first feedback message to a first wireless node, and transmitting a second feedback message to a second wireless node.

In a third aspect, alone or in combination with one or more of the first and second aspects, transmitting the at least one feedback message includes transmitting a plurality of feedback messages based at least in part on a plurality of received packets.

In a fourth aspect, alone or in combination with one or more of the first through third aspects, transmitting the at least one feedback message includes transmitting a single feedback message corresponding to a plurality of received packets.

In a fifth aspect, alone or in combination with one or more of the first through fourth aspects, the single feedback message indicates whether the plurality of received packets is successfully decoded.

In a sixth aspect, alone or in combination with one or more of the first through fifth aspects, the plurality of received packets are associated with a common stage of the multi-stage grant.

In a seventh aspect, alone or in combination with one or more of the first through sixth aspects, the plurality of received packets includes a first packet that is to be decoded and one or more second packets identifying a resource for the first packet.

In an eighth aspect, alone or in combination with one or more of the first through seventh aspects, a feedback codebook for the single feedback message is semi-static.

In a ninth aspect, alone or in combination with one or more of the first through eighth aspects, a feedback codebook for the single feedback message is dynamic based at least in part on a quantity of present packets.

In a tenth aspect, alone or in combination with one or more of the first through ninth aspects, a configuration of the single feedback message is based at least in part on at least one of: a quantity of hops in a multi-hop communication, a quantity of alternate routes for the multi-hop communication, or a quantity of sources for the plurality of received packets.

In an eleventh aspect, alone or in combination with one or more of the first through tenth aspects, a quantity of the at least one feedback message is indicated via a first stage of the multi-stage grant.

In a twelfth aspect, alone or in combination with one or more of the first through eleventh aspects, bits of the at least one feedback message are jointly encoded using a common codebook or separately encoded using separate sidelink feedback channel resources.

In a thirteenth aspect, alone or in combination with one or more of the first through twelfth aspects, the at least one sidelink communication includes one or more relaying communications associated with the relaying data received from a first wireless node, and the at least one feedback message includes at least one of: an acknowledgement of receipt of the one or more relaying communications, or an acknowledgement of successful relaying of the one or more relaying communications to a second wireless node.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:

Aspect 1: A method of wireless communication performed by a wireless communication device, comprising: receiving at least one sidelink communication on a sidelink, wherein the at least one sidelink communication includes at least one of a grant, a plurality of data packets or relaying data received on a resource identified by a grant, a multi-stage grant, a multi-packet grant, or a relaying communication; and transmitting, on the sidelink, at least one feedback message acknowledging receiving the at least one sidelink communication.

Aspect 2: The method of Aspect 1, wherein receiving the at least one sidelink communication comprises: receiving a first stage of the multi-stage grant from a first wireless node; and receiving a second stage of the multi-stage grant from a second wireless node.

Aspect 3: The method of any of Aspects 1-2, wherein transmitting the at least one feedback message comprises: transmitting a first feedback message to a first wireless node; and transmitting a second feedback message to a second wireless node.

Aspect 4: The method of any of Aspects 1-3, wherein transmitting the at least one feedback message comprises: transmitting a plurality of feedback messages based at least in part on a plurality of received packets.

Aspect 5: The method of any of Aspects 1-4, wherein transmitting the at least one feedback message comprises: transmitting a single feedback message corresponding to a plurality of received packets.

Aspect 6: The method of Aspect 5, wherein the single feedback message indicates whether the plurality of received packets is successfully decoded.

Aspect 7: The method of any of Aspects 5-6, wherein the plurality of received packets are associated with a common stage of the multi-stage grant.

Aspect 8: The method of any of Aspects 5-7, wherein the plurality of received packets includes a first packet that is to be decoded and one or more second packets identifying a resource for the first packet.

Aspect 9: The method of any of Aspects 5-8, wherein a feedback codebook for the single feedback message is semi-static.

Aspect 10: The method of any of Aspects 5-9, wherein a feedback codebook for the single feedback message is dynamic based at least in part on a quantity of present packets.

Aspect 11: The method of any of Aspects 5-10, wherein a configuration of the single feedback message is based at least in part on at least one of: a quantity of hops in a multi-hop communication, a quantity of alternate routes for the multi-hop communication, a quantity of sources for the plurality of received packets, or a combination thereof.

Aspect 12: The method of any of Aspects 1-11, wherein a quantity of the at least one feedback message is indicated via a first stage of the multi-stage grant.

Aspect 13: The method of any of Aspects 1-12, wherein bits of the at least one feedback message are jointly encoded using a common codebook or separately encoded using separate sidelink feedback channel resources.

Aspect 14: The method of any of Aspects 1-13, wherein the at least one sidelink communication includes one or more relaying communications associated with the relaying data received from a first wireless node; and wherein the at least one feedback message includes at least one of: an acknowledgement of receipt of the one or more relaying communications, an acknowledgement of successful relaying of the one or more relaying communications to a second wireless node, or a combination thereof

Aspect 15: An apparatus for wireless communication at a device, comprising a processor; memory coupled with the processor; and instructions stored in the memory and executable by the processor to cause the apparatus to perform the method of one or more Aspects of Aspects 1-14.

Aspect 16: A device for wireless communication, comprising a memory and one or more processors coupled to the memory, the memory and the one or more processors configured to perform the method of one or more Aspects of Aspects 1-14.

Aspect 17: An apparatus for wireless communication, comprising at least one means for performing the method of one or more Aspects of Aspects 1-14.

Aspect 18: A non-transitory computer-readable medium storing code for wireless communication, the code comprising instructions executable by a processor to perform the method of one or more Aspects of Aspects 1-14.

Aspect 19: A non-transitory computer-readable medium storing a set of instructions for wireless communication, the set of instructions comprising one or more instructions that, when executed by one or more processors of a device, cause the device to perform the method of one or more Aspects of Aspects 1-14.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a wireless communication device, comprising:
receiving at least one sidelink communication on a sidelink, wherein the at least one sidelink communication includes at least one of a grant, a plurality of data packets or relaying data received on a resource identified by a grant, a multi-stage grant, a multi-packet grant, or a relaying communication; and
transmitting, on the sidelink, at least one feedback message acknowledging receiving the at least one sidelink communication.

2. The method of claim 1, wherein receiving the at least one sidelink communication comprises:
receiving a first stage of the multi-stage grant from a first wireless node; and
receiving a second stage of the multi-stage grant from a second wireless node.

3. The method of claim 1, wherein transmitting the at least one feedback message comprises:
transmitting a first feedback message to a first wireless node; and
transmitting a second feedback message to a second wireless node.

4. The method of claim 1, wherein transmitting the at least one feedback message comprises:
transmitting a plurality of feedback messages based at least in part on a plurality of received packets.

5. The method of claim 1, wherein transmitting the at least one feedback message comprises:
transmitting a single feedback message corresponding to a plurality of received packets.

6. The method of claim 5, wherein the single feedback message indicates whether the plurality of received packets is successfully decoded.

7. The method of claim 5, wherein the plurality of received packets are associated with a common stage of the multi-stage grant.

8. The method of claim 5, wherein the plurality of received packets includes a first packet that is to be decoded and one or more second packets identifying a resource for the first packet.

9. The method of claim 5, wherein a feedback codebook for the single feedback message is semi-static.

10. The method of claim 5, wherein a feedback codebook for the single feedback message is dynamic based at least in part on a quantity of present packets.

11. The method of claim 5, wherein a configuration of the single feedback message is based at least in part on at least one of:
a quantity of hops in a multi-hop communication,
a quantity of alternate routes for the multi-hop communication,
a quantity of sources for the plurality of received packets, or
a combination thereof.

12. The method of claim 1, wherein a quantity of the at least one feedback message is indicated via a first stage of the multi-stage grant.

13. The method of claim 1, wherein bits of the at least one feedback message are jointly encoded using a common codebook or separately encoded using separate sidelink feedback channel resources.

14. The method of claim 1, wherein the at least one sidelink communication includes one or more relaying communications associated with the relaying data received from a first wireless node; and
wherein the at least one feedback message includes at least one of:
an acknowledgement of receipt of the one or more relaying communications,
an acknowledgement of successful relaying of the one or more relaying communications to a second wireless node, or
a combination thereof.

15. A wireless communication device for wireless communication, comprising:
a memory; and
one or more processors, coupled to the memory, configured to:
receive at least one sidelink communication on a sidelink, wherein the at least one sidelink communication includes at least one of a grant, a plurality of data packets or relaying data received on a resource identified by a grant, a multi-stage grant, a multi-packet grant, or a relaying communication; and
transmit, on the sidelink, at least one feedback message acknowledging receiving the at least one sidelink communication.

16. The wireless communication device of claim 15, wherein the one or more processors, to receive the at least one sidelink communication, are configured to:
receive a first stage of the multi-stage grant from a first wireless node; and
receive a second stage of the multi-stage grant from a second wireless node.

17. The wireless communication device of claim 15, wherein the one or more processors, to transmit the at least one feedback message, are configured to:
transmit a first feedback message to a first wireless node; and
transmit a second feedback message to a second wireless node.

18. The wireless communication device of claim 15, wherein the one or more processors, to transmit the at least one feedback message, are configured to:
transmit a plurality of feedback messages based at least in part on a plurality of received packets.

19. The wireless communication device of claim 15, wherein the one or more processors, to transmit the at least one feedback message, are configured to:
transmit a single feedback message corresponding to a plurality of received packets.

20. The wireless communication device of claim 19, wherein the single feedback message indicates whether the plurality of received packets is successfully decoded.

21. The wireless communication device of claim 19, wherein the plurality of received packets are associated with a common stage of the multi-stage grant.

22. The wireless communication device of claim 19, wherein the plurality of received packets includes a first packet that is to be decoded and one or more second packets identifying a resource for the first packet.

23. The wireless communication device of claim 19, wherein a feedback codebook for the single feedback message is semi-static.

24. The wireless communication device of claim 19, wherein a feedback codebook for the single feedback message is dynamic based at least in part on a quantity of present packets.

25. The wireless communication device of claim 19, wherein a configuration of the single feedback message is based at least in part on at least one of:
a quantity of hops in a multi-hop communication,
a quantity of alternate routes for the multi-hop communication,
a quantity of sources for the plurality of received packets, or
a combination thereof.

26. The wireless communication device of claim 15, wherein a quantity of the at least one feedback message is indicated via a first stage of the multi-stage grant.

27. The wireless communication device of claim 15, wherein bits of the at least one feedback message are jointly encoded using a common codebook or separately encoded using separate sidelink feedback channel resources.

28. The wireless communication device of claim 15, wherein the at least one sidelink communication includes one or more relaying communications associated with the relaying data received from a first wireless node; and
wherein the at least one feedback message includes at least one of:
an acknowledgement of receipt of the one or more relaying communications,
an acknowledgement of successful relaying of the one or more relaying communications to a second wireless node, or
a combination thereof.

29. A non-transitory computer-readable medium storing a set of instructions for wireless communication, the set of instructions comprising:
one or more instructions that, when executed by one or more processors of a wireless communication device, cause the wireless communication device to:
receive at least one sidelink communication on a sidelink, wherein the at least one sidelink communication includes at least one of a grant, a plurality of data packets or relaying data received on a resource identified by a grant, a multi-stage grant, a multi-packet grant, or a relaying communication; and
transmit, on the sidelink, at least one feedback message acknowledging receiving the at least one sidelink communication.

30. An apparatus for wireless communication, comprising:
means for receiving at least one sidelink communication on a sidelink, wherein the at least one sidelink communication includes at least one of a grant, a plurality of data packets or relaying data received on a resource identified by a grant, a multi-stage grant, a multi-packet grant, or a relaying communication; and
means for transmitting, on the sidelink, at least one feedback message acknowledging receiving the at least one sidelink communication.
